(19) United States
(12) Patent Application Publication
(10) Pub. No.: US 2011/0286843 A1
(43) Pub. Date: Nov. 24, 2011

(54) DRIVE DEVICE FOR DRIVING SEVERAL AXLES

(76) Inventors: Karl Lengl, Lohr (DE); Stephan Becker, Haibach (DE); Bernd Spatz, Waldschaff (DE)

(21) Appl. No.: 12/526,843

(22) PCT Filed: Feb. 6, 2008
(86) PCT No.: PCT/EP2008/051451

§ 371 Date: Aug. 10, 2011

(30) Foreign Application Priority Data
Feb. 13, 2007 (DE) 10 2007 006 966.0

(51) Int. Cl. F03D 7/00

(52) U.S. Cl. 416/31

(57) ABSTRACT

A drive device for driving at least one first axle and one second axle (axle 1, axle 2, axle 3), comprising a first control device (1, 2, 3) which subjects the at least one first axle (axle 1, axle 2, axle 3) to drive control, and comprising a second control device (1, 2, 3) which subjects the at least one second axle (axle 1, axle 2, axle 3) to drive control. A position sensor (10, 15, 20) which detects a position of the second axle (axle 1, axle 2, axle 3) is provided, and a detection signal of the position sensor (10, 15, 20) is supplied to the first control device (1, 2, 3).

### TECHNICAL AREA

The present invention relates to a drive device for driving several axles and, in particular, to an electrical drive device for driving several axles, which may be used, e.g., to electrically adjust rotor blades of a wind power plant.

### BACKGROUND INFORMATION

It is known to adjust an inclination angle of rotor blades of a rotor of a wind power plant in order to optimize an energy output of the rotor of the wind power plant, to securely bring the rotor to a standstill if a malfunction should occur, etc. The drives that are used for this purpose are referred to as pitch drives. Electrical drives are being used to an increasing extent. Brushless electrical drives in particular are not entirely fail-safe, due to the complex control devices that are required to operate them. For this reason, the capability to reliably detect a failure of a drive of this type is particularly valuable in this case. However, it should also be possible to reliably detect a failure of a controller used for direct-current drives or hydraulic drives.

The rotor blades are generally adjusted independently of one another. This means that each rotor blade includes a separate control device which operates independently of the control devices for the other rotor blades. In a typical system design, these control devices operate in a speed-control mode, and a higher-order control device which performs position control for each rotor blade is present. The setpoint position values are defined, in turn, by a higher-order system control center, e.g., as a function of the wind speed.

At least one angle-of-rotation sensor must be provided for detecting an actual value of an inclination angle of each rotor blade. However, it is possible to provide two angle-of-rotation sensors, in order to ensure redundancy. An angle-of-rotation sensor directly detects an angle of rotation, that is, an inclination angle of a rotor blade, and another angle-of-rotation sensor detects an angle of rotation of the same rotor blade directly via an angle of rotation of an electric motor that is used to adjust the angle of rotation of the rotor blade. The actual values—which are detected in this manner—of the angle of rotation of each rotor blade are supplied to the higher-order control device in order to perform position control.

In the system described initially, the higher-order control device is a weak point. If a defect occurs in this control device which is centrally located in the circuitry, reliable adjustment of the rotor blades, e.g., to attain a feathering pitch, is no longer ensured. In addition, monitoring that is independent of this central control device is not realized. In all, safe operation of the wind power plant is therefore no longer ensured.

### OBJECT OF THE INVENTION

The object of the present invention, therefore, is to eliminate the above-noted disadvantages of the prior art and to create a drive device for driving several axles that makes reliable operation possible.

### SUMMARY OF THE INVENTION

This object is achieved via the features stated in claim 1.

Further advantageous embodiments of the present invention are the subject matter of the dependent claims.

According to claim 1, the use of the detection signal that indicates a position of a second axle makes it possible to check the functionality, e.g., of a drive of a rotor blade of a wind power plant, using an independent control entity.

Furthermore, according to claim 1, the external monitoring of an axle can be carried out by a control device of a further axle, instead of by a separate safety controller. Less hardware is required than for conventional systems since the control device already includes a microcontroller. The microcontroller is also typically capable of executing a monitoring program directly. Simply by monitoring the actual position value, it is possible to carry out a check, e.g., with regard for permitted actual value intervals, or to monitor an expected velocity profile.

According to claims 2 and 3, a mutual monitoring of two or more drives corresponds to decentralized, distributed monitoring, which results in a greater level of fault tolerance. If the control devices preferably include a separate diagnostic function, as usual, this also ensures redundancy.

According to claim 4, every control device monitors exactly one other control device, thereby ensuring that the load is distributed with regard for the computing power required.

According to claim 5, a monitoring device which may be realized using a hardware module or, preferably, a software of a microcontroller, is integrated. As a result, it is possible to detect certain disturbances, e.g., a prolonged standstill, unpermitted actual values, etc., simply using an actual position value.

According to claim 6, additional possibilities for checking include, e.g., decentralized detection of the status signal of the second control device, an actual-value comparison between the position sensor of the control device and the additional position sensor, or a setpoint value/actual value comparison. In the case of synchronous expected value assignment, the separate setpoint value may also be used to check the other control device.

According to claim 7, distributed, decentralized monitoring is created, in which case an additional module or a software may be required for this degree of complexity, and all axles may be equipped with the same control device.

According to claim 8, a “pull-wire” which includes a separate reliable communication channel is provided. Every control device may report a malfunction, thereby triggering a safety sequence in the entire system.

According to claim 9, an integrated switching device which requires only minimal additional hardware outlay ensures that the most frequent breakdown scenarios, in particular a failure of a power component of a control device, may be overcome.

According to claims 10 through 12, communication may be carried out between the control devices themselves, and between control devices and devices at a higher-order level.

According to claims 13 and 14, distribution and decentralization of the monitoring is attained since the control devices are provided in a manner such that they are separated from one another. The distributed nature of the monitoring is enhanced by the fact that the control devices carry out all required open-loop control, monitoring, and closed-loop control functions, at least for the axles that they monitor.

According to claim 15, an independent energy supply is ensured for every control device, thereby increasing operational reliability.

According to claim 16, continued operation is ensured if an external power supply fails.

According to claims 17 and 18, it is possible to reliably control different systems.

### BRIEF DESCRIPTION OF THE DRAWING

The present invention is explained in greater detail below using exemplary embodiments, with reference to the attached drawings.

FIG. 1 is a schematic view of a drive device for driving several axles according to a first embodiment of the present invention;

FIG. 2 is a schematic view of a no-break power supply to drive device for driving several axles according to the first embodiment of the present invention; and

FIG. 3 is a schematic view of a drive device for driving several axles according to a second embodiment of the present invention.

### DETAILED DESCRIPTION OF THE EXEMPLARY EMBODIMENTS

It is pointed out that, although the term “axle” will be used below, this term may be mean “axle” as well as “shaft”. Potential applications include rotational as well as linear drive systems. The use of the term “axle” which is common in industrial control technology to designate an electrical or hydraulic motor in conjunction with an associated controller or control device is also incorporated herein.

It is also pointed out that the embodiments described below describe and depict the use of the drive device for driving several axles of rotor blades of a rotor of a wind power plant. The present invention is not limited to this application, however, but rather may be applied in any situation in which several axles should be driven. An application of this type is, e.g., use with adjustable axles of a tilting mechanism of rail vehicles having tilting technology, these axles being used as the “several axles”.

A first embodiment of the present invention is described below.

What is described below is a design of a drive device for driving several axles according to the first embodiment of the present invention.

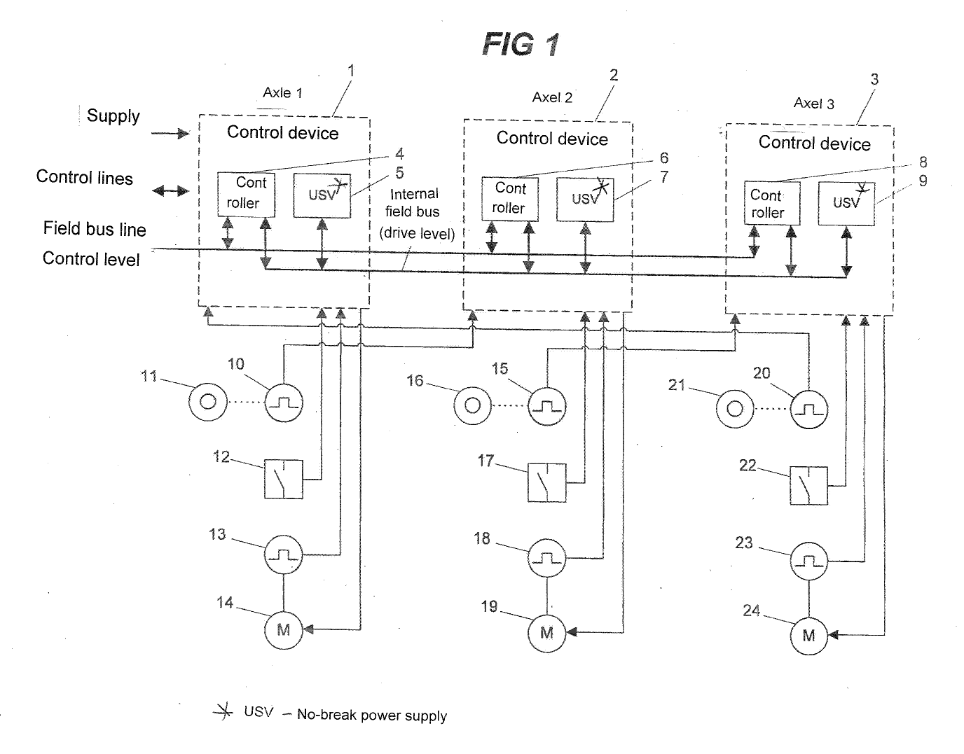

FIG. 1 is a schematic view of the drive device for driving several axles according to a first embodiment of the present invention.

As shown in FIG. 1, the drive device which is used to drive several axles includes a first control device 1, a second control device 2, and a third control device 3. First through third control devices 1 through 3 are provided for respective first through third axles which are labeled “Axle 1” through “Axle 3” in FIG. 1. First control device 1 includes a first controller 4 and a first no-break power supply 5, which is abbreviated as USV. Second control device 2 includes a second controller 6 and a second no-break power supply 7, which is abbreviated as USV. Third control device 3 includes a third controller 8 and a third no-break power supply 9, which is abbreviated as USV.

Mounted on the first axle are a first angle-of-rotation sensor 10 which detects an angle of rotation of a mechanism 11 for adjusting a rotor blade and generates a first signal which indicates an angle of rotation, a limit switch 12 and a second angle-of-rotation sensor 13 which detects an angle of rotation of an electric motor 14 for adjusting the rotor blade and generates a second signal which indicates an angle of rotation.

Mounted on the second axle are a first angle-of-rotation sensor 15 which detects an angle of rotation of a mechanism 16 for adjusting a rotor blade and generates a first signal which indicates an angle of rotation, a limit switch 17 and a second angle-of-rotation sensor 18 which detects an angle of rotation of an electric motor 19 for adjusting the rotor blade and generates a second signal which indicates an angle of rotation.

Mounted on the third axle are a first angle-of-rotation sensor 20 which detects an angle of rotation of a mechanism 21 for adjusting a rotor blade and generates a first signal which indicates an angle of rotation, a limit switch 22 and a second angle-of-rotation sensor 23 which detects an angle of rotation of an electric motor 24 for adjusting the rotor blade and generates a second signal which indicates an angle of rotation.

As shown in FIG. 1, first through third controllers 4, 6, and 8 of first through third control devices 1 through 3 are connected to a field bus line and to an internal field bus. The field bus line is used to connect external components at the control level, and the internal field bus is a connection at the drive level. First through third no-break power supplies 5, 7 and 9 are also connected to the internal field bus. In addition, respective connections for required control lines or a required energy supply are provided at first through third control devices 1 through 3.

First angle-of-rotation sensors 10, 15, and 20 are each operatively coupled to one of the mechanisms 11, 16, and 21 in order to adjust a rotor blade of first through third axles “Axle 1” through “Axle 3”. In addition, second angle-of-rotation sensors 13, 18, and 23 are each operatively coupled to one of the electric motors 14, 19, and 24 of first through third axles “Axle 1” through “Axle 3”. First angle-of-rotation sensors 10, 15, and 20, second angle-of-rotation sensors 13, 18 and 23, electric motors 14, 19, and 24, and limit switches 12, 17, 22 of first through third axles “Axle 1” through “Axle 3” are each connected to one of the first through third control devices 1 through 3 of first through third axles “Axle 1” through “Axle 3”.

It should be noted that second angle-of-rotation sensors 13, 18, and 23, electric motors 14, 19, and 24, and limit switches 12, 17, and 22 of first through third axles “Axle 1” through “Axle 3” are each connected to that first through third control device 1 through 3 that is provided for the same first through third axle “Axle 1” through “Axle 3”, while first angle-of-rotation sensor 10 of first axle “Axle 1” is connected to second control device 2 of second axle “Axle 2”, first angle-of-rotation sensor 15 of second axle “Axle 2” is connected to third control device 3 of third axle “Axle 3”, and first angle-of-rotation sensor 20 of third axle “Axle 3” is connected to first control device 1 of first axle “Axle 1”.

What is described below is the mode of operation of the drive device for driving several axles according to the first embodiment of the present invention.

As described above, first angle-of-rotation sensors 10, 15, and 20, and particular second angle-of-rotation sensors 13, 18, and 23 are provided for first through third axles “Axle 1” through “Axle 3”.

Second angle-of-rotation sensors 13, 18, and 23 each generate a signal which corresponds to an angle of rotation of respective axle “Axle 1” through “Axle 3”. This signal is supplied to control device 1 through 3 of the same axle. Second angle-of-rotation sensors 13, 18, or 23, and respective control device 1, 2, or 3 to which the signal is supplied are therefore assigned to same axle “Axle 1” through “Axle 3”. More specifically, the second signal, which indicates an angle of rotation, from second angle-of-rotation sensor 13 of first axle “Axle 1” is input into first control device 1 of first axle “Axle 1”, the second signal, which indicates an angle of rotation, from second angle-of-rotation sensor 18 of second axle “Axle 2” is input into second control device 2 of second axle “Axle 2”, and the second signal, which indicates an angle of rotation, from second angle-of-rotation sensor 23 of third axle “Axle 3” is input into third control device 3 of third axle “Axle 3”. Within particular axle “Axle 1” through “Axle 3”, this design corresponds to a typical closed loop which is known per se.

First angle-of-rotation sensors 10, 15, and 20 detect an angle of rotation of a mechanism 11, 16, and 21 for adjusting a rotor blade of first through third axles “Axle 1” through “Axle 3”, and they generate a first signal which indicates an angle of rotation of the particular axle. The following applies for each of the axles “Axle 1” through “Axle 3”: This first signal which indicates an angle of rotation of the axle is supplied to the control device of one of the other axles. More specifically, the first signal, which indicates an angle of rotation, from first angle-of-rotation sensor 10 of first axle “Axle 1” is input into second control device 2 of second axle “Axle 2”, the first signal, which indicates an angle of rotation, from first angle-of-rotation sensor 15 of second axle “Axle 2” is input into third control device 3 of third axle “Axle 3”, and the first signal, which indicates an angle of rotation, from first angle-of-rotation sensor 20 of third axle “Axle 3” is input into first control device 1 of first axle “Axle 1”.

Particular first and second signals, which indicate the angle of rotation, from first angle-of-rotation sensors 10, 15, and 20, and second angle-of-rotation sensors 13, 18, and 23 of first through third axles “Axle 1” through “Axle 3” are input into respective controllers 4, 6, and 8 of first through third control devices 1 through 3. The signals that are input in this manner are then processed in controllers 4, 6, and 8. Controllers 4, 6, and 8 are used to generate a control signal for one of the electric motors 14, 19, and 24 and to output the control signal to particular electric motor 14, 19, or 24 that is provided for the same first through third axle “Axle 1” through “Axle 3” for which particular controller 4, 6 or 8 is provided, in order to adjust a particular rotor blade which is coupled to a particular electric motor 14, 19, or 24 via a respective mechanism 11, 16 or 21.

In other words, each control device receives an angle-of-rotation signal from an axle assigned to it for driving purposes, in order to perform a control function and independent monitoring, and each control device also receives an additional angle-of-rotation signal from another, preferably adjacent axle, as shown in FIG. 1.

Given that a first signal, which indicates an angle of rotation, from one of the first angle-of-rotation sensors 10, 15, and 20 of another of the first through third axles “Axle 1” through “Axle 3”, and a second signal, which indicates an angle of rotation, from one of the second angle-of-rotation sensors 13, 18 or 23 of the same of the first through third axles “Axle 1” through “Axle 3” are input into each of the controllers 4, 6 and 8 of first through third axles “Axle 1” through “Axle 3”, it is possible to evaluate particular first and second signals, which indicate an angle of rotation, of first angle-of-rotation sensors 10, 15, and 20, and second angle-of-rotation sensors 13, 18, and 23 in a particular controller 4, 6, or 8. This means that drives of particular first through third axles “Axle 1” through “Axle 3” may check one another for disturbances. In particular, individual controllers 4, 6 and 8 are therefore subjected to monitoring by an external device, i.e., one of the other controllers 4, 6, or 8.

As mentioned above, controllers 4, 6, and 8 of first through third control devices 1 through 3 are connected at the drive level via the internal field bus. Via this internal field bus, it is possible for controllers 4, 6, and 8 to share, e.g., status messages, particular setpoint values and/or particular actual values of necessary signals and/or parameters, etc., in order to perform a mutual functionality check, for instance. It is therefore possible, e.g., to check the agreement of output signals from two angle-of-rotation sensors of a particular axle or of two different axles, or to check the agreement of an actual value with a setpoint value of a particular signal which indicates an angle of rotation, etc., within a certain position lag or operating state. Furthermore, the internal field bus at the drive level also serves as a redundant communication route, via which data from the control level may be transferred between controllers 4, 6, and 8 provided that one of the controllers 4, 6, and 8 includes a functional field bus connection to the control level.

Controllers 4, 6, and 8 are typically designed as digital control devices. These include a microcontroller, on which a controller software is executed. This controller software is preferably supplemented by a monitoring module which performs the maintenance, which is described above, of another axle based on the angle of rotation signal that is supplied. In the case of analog control devices in particular, it is possible for the monitoring function to also be carried out by an electronic circuit which is present in the control device. In both cases, identically designed control devices may be used for each control axle. Due to the minimal type variety, this has a favorable effect on the costs to store and manufacture the control devices.

Controllers 4, 6, and 8, in particular the monitoring modules, are connected to a separate physical communication channel (not depicted) which is used solely to signal a serious malfunction. This is often referred to as a pull-wire. If a controller 4, 6, or 8 or another system component reports a malfunction on the pull-wire, the functional components immediately bring the system into a safe state.

Based on the functionality check described above, it is therefore possible, for instance, to bring the rotor blades of the wind power plant into a feathering pitch after a malfunction is detected. Limit switches 12, 17, and 22 of first through third axles “Axle 1” through “Axle 3” are designed to implement a shut-off once the feathering pitch of particular rotor blades of wind power plant has been attained. The feathering pitch refers to a position in which a particular rotor blade opposes the wind that is acting on the rotor blade with the least amount of resistance. In addition, a rotor blade that has attained feathering pitch brakes the rotor in an aerodynamic manner.

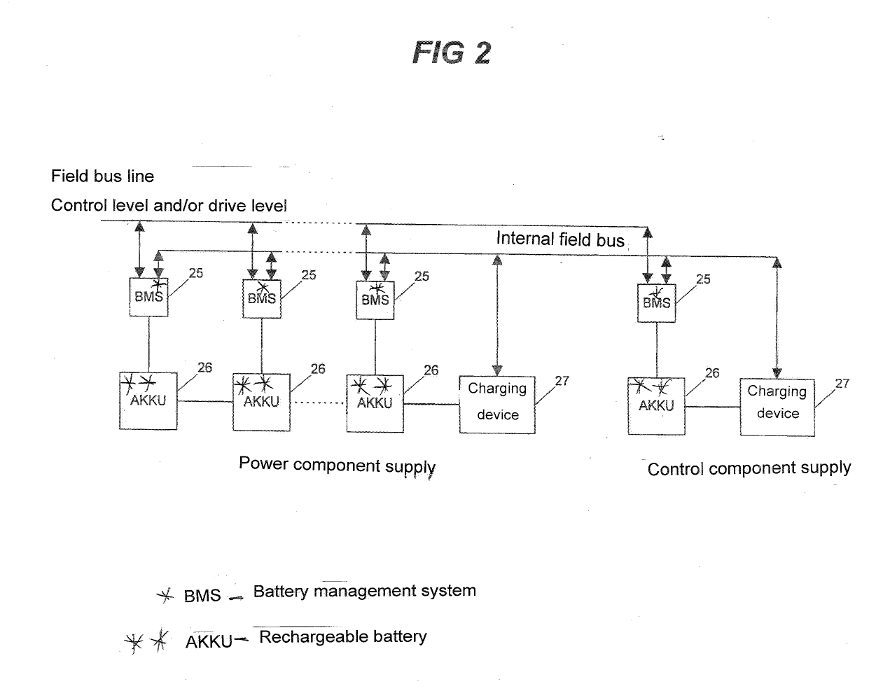

FIG. 2 is a schematic view of a no-break power supply to drive device for driving several axles according to the first embodiment of the present invention.

It should be noted that the no-break power supply shown in FIG. 2 may be used as each of the no-break power supplies 5, 7, and 9 shown in FIG. 1.

The no-break power supply includes battery management systems (BMS) 25, rechargeable battery units (“Akku”) 26, and charging devices 27.

In the embodiment shown, the no-break power supply (“USV”) is subdivided into a power supply for the power component of a controller, and into a power supply for the control component of a controller. The supply for the power component contains, e.g., twelve BMS 25 and twelve rechargeable battery units 26; a particular BMS 25 is connected to a particular rechargeable battery unit 26. When a 25-volt rechargeable battery unit is used, there is a supply voltage of 300 V for the emergency power supply to the power component. A voltage of 25 V is sufficient, for example, to supply the control component, and it is supplied by a rechargeable battery unit. The rechargeable battery unit is also equipped with a BMS 25. BMS 25 are connected to an internal field bus and, via a field bus line, to the control level and/or drive level. Charging devices 27 are also connected to BMS 25 via the internal field bus connection.

Rechargeable batteries 25) used in the no-break power supply are lithium ion rechargeable batteries which contain no “gasses” as compared to lead gel rechargeable batteries used previously. In addition, lithium ion rechargeable batteries of this type are lighter in weight than are lead gel rechargeable batteries. As shown in FIG. 1, a no-break power supply of this type is provided decentrally for each of the first through third axles “Axle 1” through “Axle 3”, thereby making it possible to incorporate an emergency power supply to first through third control devices 1 through 3 into the redundancy concept.

A second embodiment of the present invention is described below.

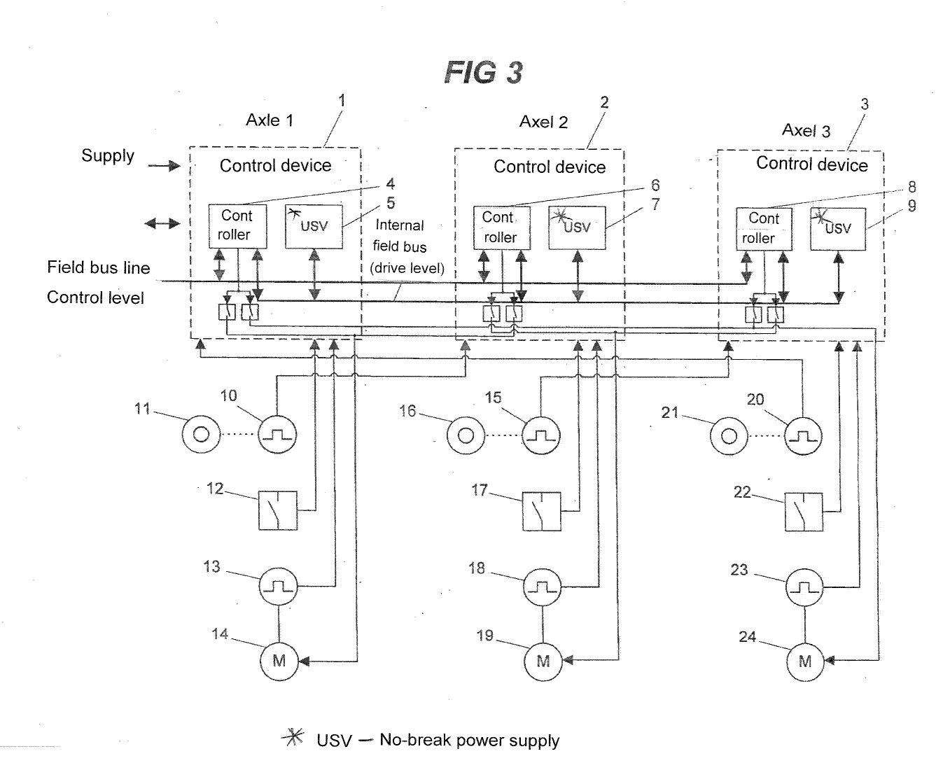

FIG. 3 is a schematic view of the drive device for driving several axles according to the second embodiment of the present invention.

Except for the changes described below, the second embodiment of the present invention is identical to the first embodiment of the present invention, and identical reference numerals refer to the same components in FIGS. 1 and 3.

As shown in FIG. 3, the drive device for driving several axles according to the second embodiment also contains two switches in each of the first through third control devices 1 through 3. These switches are used to enable each controller 4, 6, and 8 to control not only one of the motors 14, 19, and 24 assigned to it as usual, but to also control one of the motors 14, 19, and 24 of first through third axles “Axle 1” through “Axle 3” whose first signal—which indicates an angle of rotation—of first angle-of-rotation sensors 10, 15, and 20 is input by the particular controller. More specifically, first control device 1 may control motor 14 of first axle “Axle 1” or motor 24 of third axle “Axle 3”, second control device 2 may control motor 19 of second axle “Axle 2” or motor 14 of first axle “Axle 1”, and third control device 3 may control motor 24 of third axle “Axle 3” or motor 19 of second axle “Axle 2”.

Via the alternate control of two of the motors 14, 19, and 24 using one of the first through third control devices 1 through 3, it is also possible to maintain operation at a lower control rate and/or output even if one of the other of the first through third control devices 1 through 3 malfunctions. If one of the first through third control devices 1 through 3 fails completely, it is still possible to return an affected rotor blade to the feathering pitch in a controlled manner.

Although certain numbers of certain components were described in the embodiments described above, the present invention is not limited to these numbers. Instead, expedient numbers of particular components may be used for a particular application. If the axles perform a linear motion instead of a rotational motion, e.g., using a spindle drive, it is possible to use linear position sensors instead of angle-of-rotation sensors.

With regard for further features and advantages of the present invention, reference is made expressly to the disclosure of the drawings.

What is claimed is:

1. A drive device for driving at least one first axle and one second axle (axle 1, axle 2, axle 3), comprising a first control device (1, 2, 3) which subjects the at least one first axle (axle 1, axle 2, axle 3) to drive control, and comprising a second control device (1, 2, 3) which subjects the at least one second axle (axle 1, axle 2, axle 3) to drive control,
wherein
a position sensor (10, 15, 20) which detects a position of the second axle (axle 1, axle 2, axle 3) is provided, and a detection signal of the position sensor (10, 15, 20) is supplied to the first control device (1, 2, 3).

2. The drive device as recited in claim 1,
wherein
a position sensor (10, 15, 20) which detects a position of the first axle (axle 1, axle 2, axle 3) is provided, and a detection signal of the position sensor (10, 15, 20) is supplied to the second control device (1, 2, 3).

3. The drive device as recited in claim 1,
wherein
at least one further axle (axle 1, axle 2, axle 3) to which a control device (1, 2, 3) is assigned in the sense of a drive control is provided, wherein a position sensor (10, 15, 20) for detecting the position of this axle is provided at each of the stated axles (axle 1, axle 2, axle 3) in addition to the control device (1, 2, 3) assigned thereto, and wherein a detection signal of the particular position sensor (10, 15, 20) is supplied to a control device (1, 2, 3) other than the one to which this axle (axle 1, axle 2, axle 3) is assigned.

4. The drive device as recited in claim 3,
wherein
the detection signals of the additional position sensors (10, 15, 20), in turn, are each assigned to a control device (1, 2, 3) other than the one to which the particular axle (axle 1, axle 2, axle 3) is assigned.

5. The drive device as recited in claim 1,
wherein
at least the first control device (1, 2, 3) includes a monitoring device to which the detection signal which indicates the position of the second axle (axle 1, axle 2, axle 3) is supplied, and using which it is possible to detect a malfunction of the second control device (1, 2, 3) based on the detection signal.

6. The drive device as recited in claim 5,
wherein,
in addition to the detection signal, at least one of the following signals is supplied to the monitoring device: a status signal from the second control device (1, 2, 3), an actual position value detected by the second control device (1, 2, 3), a setpoint value supplied to the second control device (1, 2, 3), and a setpoint value supplied to the first control device (1, 2, 3).

7. The drive device as recited in claim 5,
wherein
each of the control devices (1, 2, 3) assigned to the second and/or further axles (axle 1, axle 2, axle 3) also include a monitoring device for monitoring one of the other axles (1, 2, 3).

8. The drive device as recited in claim 5,
wherein
the monitoring device is connected to a separate physical communication channel, via which a malfunction of the device device may be signaled, in particular a malfunction of the control device (1, 2, 3) that is being monitored.

9. The drive device as recited in claim 1,
wherein
at least the first control device (1, 2, 3) includes a switching device, using which a correcting variable output by the first control device (1, 2, 3) may be supplied to an axle (axle 1, axle 2, axle 3) other than the first axle (axle 1, axle 2, axle 3).

10. The drive device as recited in claim 1,
wherein
control devices (1, 2, 3) are interconnected for communication purposes.

11. The drive device as recited in claim 10,
wherein
control devices (1, 2, 3) are connected at a drive level via a field bus.

12. The drive device as recited in claim 11,
wherein
at least one control device (1, 2, 3) is connected to a control level, and data from the control level are transmitted between control devices (1, 2, 3) via the field bus at the drive level.

13. The drive device as recited in claim 1,
wherein
control devices (1, 2, 3) for axles (axle 1, axle 2, axle 3) that they drive are provided in a manner such that they are separated from one another.

14. The drive device as recited in claim 13,
wherein
control devices (1, 2, 3) perform all open-loop control, monitoring, and closed-loop control functions required for the axles (axle 1, axle 2, axle 3) that they drive.

15. The drive device as recited in claim 13,
wherein
control devices (1, 2, 3) which are separated from one another include energy supply devices (5, 7, 9) which are separated from one another, with one energy supply device (5, 7, 9) being assigned to one control device (1, 2, 3).

16. The drive device as recited in claim 5,
wherein
energy supply devices include no-break power supplies (5, 7, 9).

17. The drive device as recited in claim 1,
wherein
the stated axles (axle 1, axle 2, axle 3) are axles of rotor blades, which should be adjusted, of a wind power plant.

18. The device as recited in claim 1,
wherein
the stated axles (axle 1, axle 2, axle 3) are axles of rotor blades, which should be adjusted, of a tilt mechanism of rail vehicles having tilting technology.
